(19) United States
(12) Patent Application Publication
(10) Pub. No.: US 2007/0231146 A1
(43) Pub. Date: Oct. 4, 2007

(54) ROTOR BLADE FOR WIND ENERGY PLANTS

(75) Inventors: Jochen Birkemeyer, Norderstedt (DE); Hermann Rochholz, Norderstedt (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Nordex Energy GmbH, Norderstedt (DE)

(21) Appl. No.: 11/690,307

(22) Filed: Mar. 23, 2007

(30) Foreign Application Priority Data
Mar. 30, 2006 (DE) 10 2006 014 742.1

(51) Int. Cl. B64C 11/04

(52) U.S. Cl. 416/204 R

(57) ABSTRACT

A rotor blade for wind energy plants with a multiplicity of cross bores running transversely to the longitudinal axis of the rotor blade in the region of the blade base, which are provided for the accommodation of cross pins, wherein for fastening the rotor blade on a rotor blade fixture, tensioning elements act upon the cross pins wherein at least one of the cross bores has a distance from the hub-side rotor blade edge which is different from the distance of a further cross bore from the rotor blade edge.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a rotor blade for wind energy plants with a multiplicity of cross bores, running transversely to the longitudinal axis of the rotor blade in the region of the blade base, which are provided for receiving cross pins, wherein for fastening the rotor blade on a rotor blade fixture, tensioning elements act upon the cross pins.

Such fastening solutions for rotor blades with cross pins and tensioning elements are commonly known. In modern wind energy plants, high mechanical loads occur in the connection region between hub and rotor blades. These loads increase significantly with wind energy plants becoming larger and larger. In connection with the intended weight saving construction, this necessitates highest demands on the construction of the parts for mounting the rotor blade. Accordingly, quite a series of different approaches to improve the main principle have been excogitated.

For instance, from DE 3 103 710 A1, the entire contents of which are incorporated herein by reference, it has become known to provide a rotor blade of fibre reinforced plastic material with an annular connection end in the region of the blade base and to lead the fibre orientation in this region essentially in the longitudinal direction of the rotor blade using a certain method, in order to be able to receive greater forces in the region of the cross bores. Further, the weakening of the rotor blade shells by the cross bores has been recognised and reinforcement of the blade base by additional covering layers with crosswise fibre orientation was suggested. Such a reinforcement of the rotor blade shells by additional layers of material has limits with great rotor blades, because the dissipation of the heath occurring in the curing of the matrix material of the fibre reinforced plastic via an exothermic reaction is a problem when the thickness of the wall increases. In addition, the necessary expense of material is increased.

From DE 3 109 566 A1, the entire contents of which is incorporated herein by reference, it is known to connect two rotor blade segments by uniform strength bolts, which are anchored in a rotor blade segment by cross pins and are set into a defined pre-tension by a special equipment.

From U.S. Pat. No. 4,236,873, the entire contents of which is incorporated herein by reference, it has become known to reinforce the fibre compound material of the rotor blade by inner and outer steel-made adapter sleeves in the region of the fastening. The cross pins run through the fibre compound material and both metallic reinforcements.

DE 197 33 372 C1, the entire contents of which is incorporated herein by reference, shows an alternative method of attachment, in which the cross pins do not sit in cross bores running through the whole rotor blade shell, but the cross pins are made shorter and are mounted in pocket bores on the inner and outer side of the rotor blade shell and co-operate with corresponding tensioning elements. The weakening of the rotor blade by the cross bores can be reduced through this.

An other possibility to fasten the rotor blade has become known from DE 103 24 166 B4, the entire contents of which is incorporated herein by reference. In this, the Cross pins extend through the whole rotor blade shell and hang over on the inner and outer side thereof. The tensioning elements are connected with the cross pins in the region of these overhangs and run outside the rotor blade shell. Through this, it is intended to avoid additional weakening of the rotor blade by the bores for the tensioning elements which usually run in the interior of the rotor blade shell.

Finally, from DE 102 14 340 C1 and WO03/057457 A1, the entire contents of which are incorporated herein by reference, further techniques have become known, in which special fastening elements with more complicated form are incorporated into the rotor blade shells for anchoring the tensioning elements in the rotor blade.

Departing from this, it is the objective of the present invention to provide a rotor blade for wind energy plants which improves the known simple fastening solution with cross pins and tensioning elements with respect to the attainable strength.

### BRIEF SUMMARY OF THE INVENTION

The rotor blade according to the present invention has a multiplicity of cross bores running transversely to the longitudinal axis of the rotor blade in the region of the blade base, which are provided for receiving cross pins, wherein for fastening the rotor blade on a rotor blade fixture, tensioning elements act upon the cross pins. The rotor blade is characterised in that at least one of the cross bores has a distance from the hub-side rotor blade edge which is different from the distance of a further cross bore from the hub-side rotor blade edge.

The present invention is based on the finding that in the conventional arrangement of the cross bores in equal distances from the hub-side rotor blade edge, the weakening of the rotor blade by the cross bores is increased because relatively little material between the bores remains when the cross bores are closely neighbouring each other. In addition, a material fracture along the straight line formed by the cross bores can be favoured in the conventional arrangement of the cross bores. Furthermore, when using the usual Triax material, in which parts of the fibre bundles run in an angle of about 45° to the longitudinal axis of the rotor blade, depending of the circumstances a big part of these angled fibres is severed by the closely neighbouring cross bores, which additionally decreases the stressability.

The rotor blade fixture can be formed immediately on the hub of the wind energy plant or it may be formed by a separate fastening flange, which on its turn is connected to the hub. As the tensioning elements, which act upon the cross pins, threaded pins come into consideration in particular, which are screwed together with the cross pins. The cross bores running transversely to the longitudinal axis of the rotor blade may also form an angle with the longitudinal axis which differs from 90°, thus “transversely” is not limited to the orthogonal direction.

Through the arrangement of the cross bores according to the present invention it is achieved that at equal number of cross bores, the distances between two cross bores increase with respect to an arrangement on a straight line. Through this, a higher stability of the material remaining between two cross bores is achieved. The danger of a material fracture along the connection line between the cross bores is decreased. An additional advantage is that the blade flange can be made thinner in the region of the cross pins, through which the bending stress of the correspondingly shorter cross pins is decreased. As the case may be, the number of pins may also be increased. Altogether, the strength of the rotor blade fixture is improved.

It is particularly advantageous that the realisation of a rotor blade according to the present invention is possible in a very simple way using conventional manufacturing techniques. No additional cost for the manufacture of the rotor blade or a changeover of an existing production worth to be mentioned is generated.

According to one preferred embodiment of the present invention, the cross bores are disposed on two circles circulating parallel around the rotor blade base, which have a different distance from the hub-side rotor blade edge. Thus, only two different distances between the cross bores and the hub-side rotor blade edge are used.

Preferably, the cross bores are disposed offset on the two circulating circles, so that the connecting line between neighbouring cross bores is a zigzag line. Further, it is preferred that the distances between each two cross bores neighbouring on the zigzag line are equal. Thus, a symmetric zigzag line with bridges of uniform width between two neighbouring cross bores results.

In one preferred embodiment of the present invention, the distance between the two parallel circles is about half the distance between two cross bores neighbouring on one circle. By this special arrangement of the cross bores, the teeth of the zigzag line, i.e., the connecting lines running from one cross bore to its neighbouring cross bores, have an angle of 90°.

According to a further embodiment of the present invention, one longitudinal bore running transversely to the direction of the cross bore is provided for each cross bore, which leads from the cross bore to the hub-side rotor blade edge and which accommodates the tensioning elements. Thus, in this case the tensioning elements are in the interior of the rotor blade shell. Alternatively, it is also possible to guide the tensioning elements outside the rotor blade shell, by which an additional weakening of the rotor blade shell through the longitudinal bores can be avoided. However, when guiding the tensioning element inside a longitudinal bore in the rotor blade shell, an advantageous symmetrical connection to the cross pin can be realised with one single tensioning element.

In a further embodiment of the present invention, the cross bores are realised as pocket bores. I.e., the cross bores are not realised as through bores, which run through the entire wall of the rotor blade, but they serve for the accommodation of shorter cross pins. Through this, the weakening of the rotor blade by each individual cross bore can be avoided.

According to a further preferred embodiment of the present invention, the wall of the rotor blade is reinforced in the region of the cross bores. For the purpose of reinforcement, the thickness of the material in this region may be enhanced, by additional fibre layers for instance, or additional reinforcement elements can be applied to the wall of the rotor blade or be incorporated into it.

### BRIEF DESCRIPTION OF THE SEVERAL VIEWS OF THE DRAWINGS

In the following, the present invention is explained in more detail by an example of its realisation represented in two figures.

FIG. 1 shows a schematic, perspective view of the blade base of a rotor blade according to the present invention,

FIG. 2 shows a cross section through the wall of a rotor blade according to the present invention in the longitudinal direction thereof, which is connected with a rotor blade fixture, along a cross bore and a longitudinal bore,

FIG. 3 shows a schematic view of the cross and longitudinal bores in a cut-out of a rotor blade shell.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

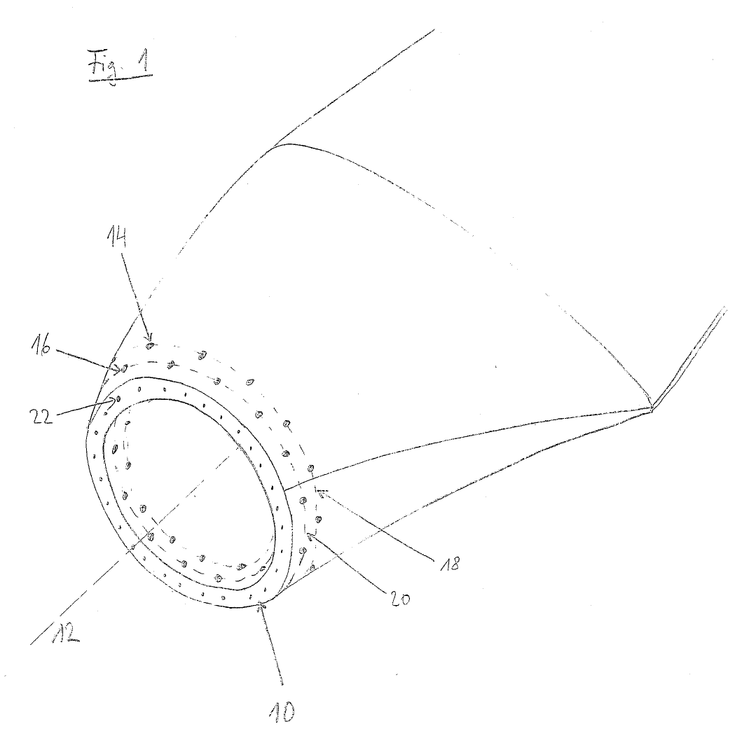

The rotor blade, the blade base of which is outlined in FIG. 1, is made up of two half-shells from fibre reinforced plastic material in a per se known manner. On the hub-side end of the rotor blade, there is the hub-side rotor blade edge 10, which is formed by an approximately circular annular plane. The width of the ring corresponds to the material thickness of the rotor blade shells in this region. The longitudinal axis of the rotor blade is indicated at 12. The hub-side rotor blade edge 10 is aligned essentially vertical to the longitudinal axis 12.

The rotor blade is provided with a multiplicity of cross bores 14, 16. The cross bores 14, 16 are aligned transversely to the longitudinal axis 12 of the rotor blade, approximately vertically to it in the shown example. However, depending on the shape of the rotor blade and of the rotor blade fixture 38 not shown in FIG. 1 near the hub of the wind energy plant, they may be also inclined with respect to the longitudinal axis 12 of the rotor blade.

The cross bores 14 are disposed on a circle indicated in broken lines at 18, which circulates around the whole rotor blade base. Corresponding therewith, the cross bores 16 are located on a second circulating circle 20. Through this, all the cross bores 16 disposed on the circle 20 have the same distance from the hub-side rotor blade edge 10. The distance of the cross bores 14, which are disposed on the circle 18, is also uniform and in the shown example it is about twice the distance of the cross bores 16 from the he hub-side rotor blade edge 10.

Further, FIG. 1 shows longitudinal bores 22, which are each one assigned to one cross bore 14, 16. Each longitudinal bore 22 leads from the hub-side rotor blade edge 10 to one cross bore 14, 16. Thus, the longitudinal bores 22 have two different lengths, depending on whether they belong to a cross bore 14 on the circle 18 or to a cross bore 16 on the circle 20. The longitudinal bores 22 are for receiving tensioning elements, by which the cross pins to be inserted into the cross bores are tensioned with respect to the rotor blade fixture.

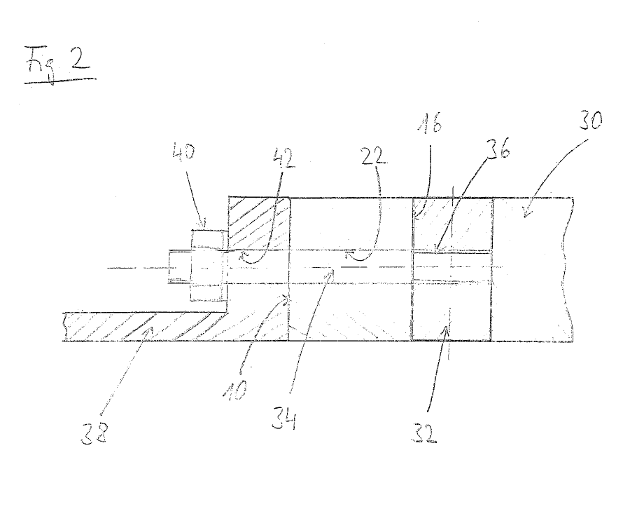

In FIG. 2, a cross section through a wall 30 of a rotor blade fixed on a rotor blade fixture 38 according to FIG. 1 is shown. The hub-side rotor blade edge 10 sits closely on the rotor blade fixture 38. A cross pin 32 is put into the cross bore 16 in the wall 30. Via a thread 36, a tensioning element is screwed together with this cross pin 32, which is realised as a cylindrical pin 34. The pin 34 runs inside a longitudinal bore 22 in the wall 30, which leads from the hub-side rotor blade edge 10 to the cross bore 16, and further through a bore 42 in the rotor blade accommodation 38, where it is secured by a nut 40 and by doing so, it tensions the rotor blade with respect to the rotor blade fixture.

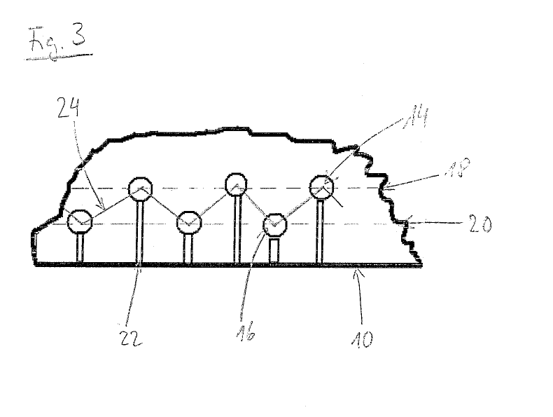

In FIG. 3, an arrangement of the cross- and longitudinal bores is again schematically shown for a cut-out of a rotor blade shell from FIG. 1. The same reference signs as in FIG. 1 are used. As a supplement, the zigzag line which connects cross bores 14, 16 neighbouring at a time with each other is drawn with 24. The diameter of the cross bores 14, 16 is about twice the diameter of the longitudinal bores 22. Through this, the tensioning elements 34 to be incorporated into the longitudinal bores 22 can be advantageously screwed by a thread 36 into the cross pins 32, which are to be inserted into the cross bores 14, 16.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A rotor blade for wind energy plants with a multiplicity of cross bores (14, 16), running transversely to the longitudinal axis of the rotor blade in the region of the blade base, which are provided for receiving cross pins (32), wherein for fastening the rotor blade on a rotor blade fixture (38), tensioning elements (34) act upon the cross pins (32), characterised in that at least one of the cross bores (14) has a distance from the hub-side rotor blade edge (10) which is different from the distance of a further cross bore (16) from the rotor blade edge (10).

2. A rotor blade according to claim 1, characterised in that the cross bores (14, 16) are disposed on two circles (18, 20) circulating parallel around the rotor blade base, which have a different distance from the hub-side rotor blade edge (10).

3. A rotor blade according to claim 2, characterised in that the cross bores (14, 16) are disposed offset on the two circulating circles (18, 20), so that the connecting line between neighbouring cross bores is a zigzag line (24).

4. A rotor blade according to claim 3, characterised in that the distances between each two cross bores (14, 16) neighbouring on the zigzag line (24) are equal.

5. A rotor blade according to claim 2, characterised in that the distance between the two parallel circles (18, 20) is about half the distance between two cross bores (14, 16) neighbouring on one circle.

6. A rotor blade according to claim 1, characterised in that one longitudinal bore (22) running transversely to the direction of the cross bore (14, 16) is provided for each cross bore (14, 16), which leads from the Cross bore (14, 16) to the hub-side rotor blade edge (10) and which accommodates the tensioning elements (34).

7. A rotor blade according to claim 1, characterised in that the Cross bores (14, 16) are realised as pocket bores.

8. A rotor blade according to claim 1, characterised in that the wall (30) of the rotor blade is reinforced in the region of the cross bores (14, 16).
